(19) United States
(12) Patent Application Publication
(10) Pub. No.: US 2002/0077071 A1
(43) Pub. Date: Jun. 20, 2002

(54) Spin polarized wave division

(76) Inventors: Lawrence I. Williams, Yorba Linda, CA (US); P. Premkumar, Wexford, PA (US)

Correspondence Address: BUCHANAN INGERSOLL, P.C., 301 GRANT STREET, 20TH FLOOR, PITTSBURGH, PA, 15219

(21) Appl. No.: 09/900,660

(22) Filed: Jul. 6, 2001

Related U.S. Application Data
(60) Provisional application No. 60/218,932, filed on Jul. 14, 2000.

(51) Int. Cl. H04B 1/00

(52) U.S. Cl. 455/130; 455/205

(57) ABSTRACT

This invention discloses methods for polarization modulation for fiber optic and wireless applications. A brief background discussion of polarization for plane electromagnetic waves is provided, including representation of the of the unique polarization state of a wave using the Poincare sphere. Extensions required for polarization modulation are disclosed as an improvement to the modulation techniques commonly used in digital broadband communications. A novel spinning linear polarization multiplexing method called Spin Polarized Wave Division is also disclosed.

This patent application is closely related to my pending Provision Patent Application Serial No. 60/218,932 filed on Jul. 14, 200.

### FIELD OF THE INVENTION

This invention deals with the field of electromagnetic waves travelling through a medium, specifically, digital fiber and wireless media, and proposes new methods for the modulation of those waves.

### BACKGROUND OF THE INVENTION

A fundamental property of electromagnetic waves is polarization. The majority of prior art existing communications systems do not take full advantage this important “degree of freedom” in their modulation schemes. The simplest polarization state of an electromagnetic wave is linear polarization. A linearly-polarized wave has an electric field vector which harmonically rises and falls along a line and, in a homogenous medium, will remain in a single plane along the direction of propagation. Linear vertical polarized waves have their electric field vector along the vertical direction; linear horizontal polarized waves have electric field vector along the horizontal direction. As an example, traditional AM and FM broadcast radio use linear vertical polarized waves. If vertically- and horizontally-polarized waves are transmitted simultaneously, with an appropriate phase-shift, the combined signal has an electric field vector that rotates as it propagates. The most general polarization state is that of elliptical polarization wherein the tip of the electric field vector traverses an ellipse. A special case called circular polarization occurs whenever the two components are equal-amplitude and in phase quadrature (±90° phase shift).

Digital modulation is the process by which digital signals are transformed into waveforms that are compatible with a particular communications channel. The general (scalar) analytic express of a bandpass modulation waveform is:

s(t)=A cos [ω₀t+φ]] (1)

where

A is the amplitude of the wave

ω₀ is the radian frequency of the carrier, and

φ is the phase.

Traditional modulation techniques vary the amplitude (amplitude modulation), the frequency (frequency modulation), or the phase (phase modulation). Coherent digital communication modulation techniques include amplitude shift keying (ASK), frequency shift keying (FSK), and phase shift keying (PSK). Non-coherent digital communication modulation techniques include the above and also differential phase shift keying (DPSK). There are numerous variants of the basic techniques that perform additional channel coding and/or multiplexing, however, for the vast majority of systems, only the aforementioned characteristics of the carrier wave are varied to transmit information.

Digital modulation schemes known in the art modify the amplitude, frequency, and phase of a sinusoidal signal to transmit digital information. In that which follows, a brief analytical description of digital modulation formats will be outlined as background for polarization modulation methods. Analytic expressions for the various waveforms used in the digital modulation methods will be summarized.

Amplitude Shift Keying (ASK)

ASK has a waveform with general analytic expression given by the equation:

s₁(t)=Aᵢ(t) cos (ω₀t+φ) 0≦t≦T (8)

i=1, 2, . . . , M

where the amplitude term, Aᵢ(t), will have M discrete values, ω₀ is the fixed carrier frequency, and φ is an arbitrary phase constant. Binary ASK signaling (also known as on-off keying) was one of the first digital modulation methods used. For binary ASK, there are M=2 states: on and off. In the general M-ary signaling case, the processor accepts k source bits at a time and instructs the modulator to produce one of an available set of M=2^{k} waveform types. Binary modulation, where k=1 and M=2, is just a special case of M-ary ASK modulation.

Frequency Shift Keying (FSK)

FSK has a waveform with general analytic expression given by the equation:

sᵢ(t)=A cos (ω₀t+φ) 0≦t≦T (9)

i=1, 2, . . . , M

where the amplitude term, ωᵢ, will have M discrete values, A is the fixed carrier amplitude, and φ is an arbitrary phase constant. It can be shown, that the waveforms of FSK are mutually orthogonal to one another. Orthogonal signals have the unique feature that increasing k (or M improves the bit error performance for a given channel signal to noise ratio. This improvement, however, comes at the expense of bandwidth.

Phase Shift Keying (PSK)

PSK has a waveform with general analytic expression given by the equation:

s₁(t)=A cos (ω₀t+φ₁(t)) 0≦t≦T (10)

i=1, 2, . . . , M

where the phase term φᵢ(t), will have M discrete values, ω₀ is the fixed carrier frequency, and A is the fixed carrier amplitude. For PSK, increasing K (or M) degrades bit error performance for a given signal to noise ration. For M-ary multiple phase shift keying (MPSK), as k increases, a larger bit rate can be transmitted within the same bandwidth. For this reason, MPSK is particularly popular for high data rates on limited bandwidth channels. Instead of using a binary alphabet with one bit of information per channel symbol period, an alphabet of M symbols is used, allowing transmission of k=log₂ M bits during each symbol period. The use of M-ary symbols allows a k-fold increase in the data rate within the same bandwidth. Alternatively, for a fixed data rate, use of M-ary PSK reduces the required bandwidth by a factor k.

Amplitude Phase Keying (APK)

APK combines an indexing of amplitude and phase. The APK waveform has a general analytic expression given by the equation:

sᵢ(t)=A₁(t) cos (ω₀t+φ₁(t)) 0≦t≦T (9)

i=1, 2, . . . , M

where the amplitude term, Aᵢ(t), and the phase term, φᵢ(t) will have M discrete values, and ω₀ is the fixed carrier frequency. The very popular quadrature amplitude modulation (QAM) can be viewed as two independently amplitude-modulated carriers that are in phase quadrature. FIG. 2 illustrates the signal vectors for a 16-ary QAM system and an associated transceiver system. Two amplitude modulated baseband signals mᵢ(t) and m_{q}(t) are mixed with the | and Q carrier signals, summed and transmitted across the channel. The signals can be separated at the receiver by synchronous detection using two local carriers in phase quadrature. This can be illustrated by considering the receiver mixer output x_{I}(t) of the in-phase channel:

$$\begin{matrix}{x}_{I} ( t ) = 2 [ {m}_{I} ( t ) cos {ω}_{0} t + {m}_{Q} ( t ) sin {ω}_{0} ] cos {ω}_{0} t \\ = {m}_{I} ( t ) + {m}_{I} ( t ) cos 2 {ω}_{0} t + {m}_{Q} ( t ) sin 2 {ω}_{0} t\end{matrix} \qquad ( 12 )$$

The last two terms will be suppressed by the lowpass filter, yielding the desired output mᵢ(t). Similarly, the output of the quadrature channel can be shown to be m_{q}(t). FIG. 2(b) illustrates a receiver using direct conversion for simplicity. For radio wave communications, it may be more practical to use a traditional superhetrodyne receiver.

As with M-ary PSK, bandwidth efficiency can be exchanged for signal to noise ratio. QAM, however, provides a much more efficient exchange than is possible for M-ary PSK.

### SUMMARY OF THE INVENTION

Signals that propagate in digital fiber and wireless communications systems are electromagnetic waves. These electromagnetic waves are vector waves, not simply scalar signals. This invention discloses a method whereby the polarization of an electromagnetic wave can be varied to modulate the carrier signal. Additional complexity will be required for transmitters, receivers, and antennas to support dual polarization. Antenna systems that support two orthogonal polarizations, e.g., linear vertical and linear horizontal or RHCP and LHCP, will be able to communicate at least twice the information possible on a single polarized system without increasing the bandwidth requirements. This invention discloses several polarization modulation and multiplexing techniques.

### DESCRIPTION OF THE DRAWINGS

FIG. 1 shows a Poincare Sphere representation of polarization states.

FIG. 2a shows a 16-ary QAM signal vector diagram.

FIG. 2b shows an example of a QAM receiver.

FIG. 3a shows a vector state diagram for M=16 in a M-ary linear polarization rotation modulation.

FIG. 3b shows a proposed transceiver for the modulation of FIG. 3a.

FIG. 4 shows SPSK transmission constellations (a) Binary, (b) 4-SPSK and (c) 8-SPSK

FIG. 5a shows a transmitter capable of producing any polarization state for SPSK communication.

FIG. 5b shows a Stoke's receiver.

FIG. 6a shows a transmitter for spin polarized wave modulation.

### DETAILED DESCRIPTION OF THE INVENTION

A more general form than equation (1) for the time-varying signal in communications systems is that of a uniform plane wave traveling along the z-direction:

\vec{E}(t,z)=\hat{x}Eₓ cos [ωt−βz+φ]+ŷE_{y} cos [ωt−βzφ+δ] (2)

where

β is the propagation constant in a loss-less medium, and

δ is the phase by which the y-component leads the x-component.

(Eₓ, E_{y}) and ω can be functions of time for the general case of amplitude and frequency modulation, respectively.

For simplicity, take z=φ=0 since the same process occurs at any location along the z-axis and the absolute phase reference is arbitrary. Now equation (2) becomes:

\vec{E}(t)=\hat{x}Eₓ cos ωt+ŷE_{y} cos (ωt+δ) (3)

illustrating the explicit decomposition of the wave into two vector components, oscillating at radian frequency ω, separated by a phase difference δ. From equation (3), we may construct any polarization state by appropriate manipulation of Eₓ, E_{y}, and δ. The absolute magnitude of Eₓ and E_{y} is less important than their ratio for determination of polarization state. We define γ=tan⁻¹E_{y}/Eₓ as one of the two independent parameters (γ, δ) that completely describe the polarization state of the wave. Table 1 below provides an outline of common polarization states using these parameters.

TABLE 1
Representations of Common Polarization States.

| Eₓ | E_{y} | $γ = {tan}^{- 1} \frac{{E}_{y}}{{E}_{x}}$ | δ | POLARIZATION STATE |
|---|---|---|---|---|
| 1 | 0° | 0° | N/A | Linear Horizontal |
| 0 | 1 | 90° | N/A | Linear Vertical |
| $1 / \sqrt{2}$ | $1 / \sqrt{2}$ | 45° | 0° | 45° Slant Linear |
| $1 / \sqrt{2}$ | $1 / \sqrt{2}$ | 135° | 0° | 135° Slant Linear |
| $1 / \sqrt{2}$ | $1 / \sqrt{2}$ | 45° | 90° | Left-Hand Circular |
| $1 / \sqrt{2}$ | $1 / \sqrt{2}$ | 45° | −90° | Right-Hand Circular |

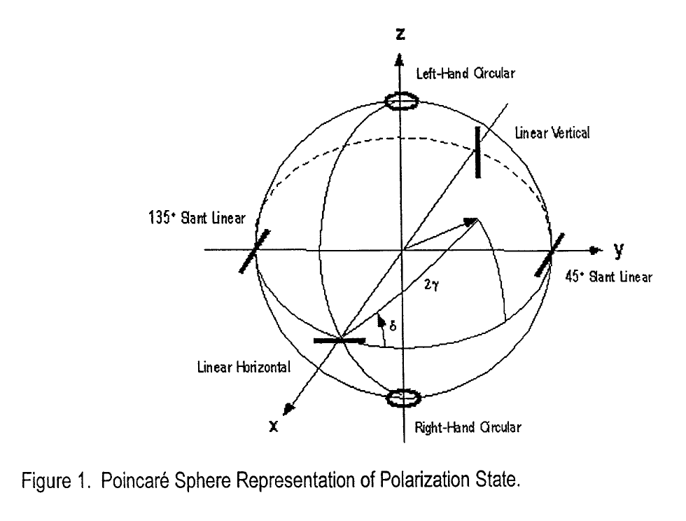

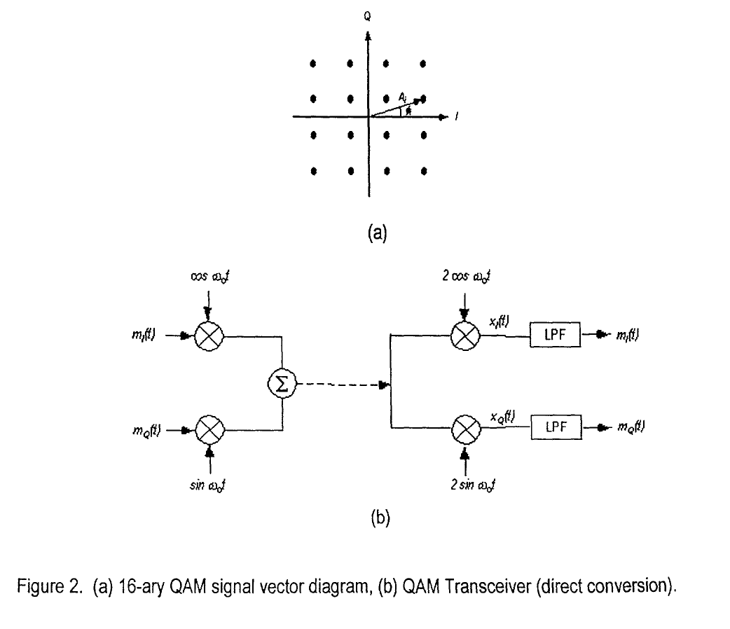

There exist a continuum of polarization states described by the parameters (γ, δ). Every possible polarization sate may be assigned to a point on the Poincare Sphere. FIG. 1 depicts the sphere, with indication of the six common polarization occurs for any state that is off the equator. Left-hand elliptical states are above the equator; right-hand elliptical states are below. Circular polarization is a special case of elliptical polarization that occurs at the poles.

The six polarization states listed in Table 1 may be considered as special cases of polarization that exist at the intersection of the Poincare Sphere and the Cartesian coordinate axes. In subsequent sections of this manuscript it will be useful to measure the “degree” to which a received wave exhibits one of these special cases. The Stoke's Parameters provide a measure of a polarized wave's proximity to one of these six extremes. Indeed, these parameters are simply the projection of the wave state onto the Cartesian axes.

Stoke's parameters are given by

S₀=|Eₓ|²+|E_{y}|² (4)

S₁=|Eₓ|²−|E_{y}|² (5)

S₂=2|Eₓ|└E_{y}┘·cos δ (6)

S₃=2|Eₓ|└E_{y}┘·sin δ (7)

Polarization Modulation

Equation (3) gives a general analytic expression for an arbitrarily-polarized plane wave at a fixed reference location. From the preceding discussion, it should be clear that the amplitude, frequency and phase of the wave may be modulated using ASK, FSK, and PSK techniques, respectively.

Polarization modulation combines an indexing of the ratio of vector component amplitudes and the phase shift between components. That is, the two parameters, (γ, δ), that determine the polarization state of the wave are indexed over M discrete values to configure an M-ary modulation scheme. It is natural to name this modulation method Polarization Shift Keying (PolSK)[ref], or Stokes Parameters Shift Keying (SPSK)[ref].

Polarization Shift Keying (PolSK)

PSK has a waveform with general analytic express given by:

\vec{E}(t)=\hat{x}Eᵢₓ(t) cos ωt+ŷE_{iy}(t) cos (ωt+δ(t)) 0≦t≦T (13)

i=1, 2, . . . , M

with the restriction that the ratio between Eᵢₓ(t) and E_{iy}(t) is given by γᵢ(t)=tan⁻¹ E_{iy}(t)/Eᵢₓ(t). A more explicit expression that highlights the dependence on [γᵢ(t),δᵢ(t)] is

\vec{E}(t)=E₀[\hat{x} cos γᵢ(t) cos ωt+ŷ sin γ₁(t) cos (ωt+δᵢ(t))] (14)

0≦t≦T 0≦γi(t)≦90

i=1, 2, . . . , M −180≦δ₁(t)≦180

Equation (14) forms the basis for numerous digital communications modulation methods. Just as was the case for scalar signals, one or more of the parameters may be varied to configure a particular modulation method. (For ASK, FSK and PSK, only one parameter is altered at a time; for APK and QAM, two parameters (amplitude and phase) are varied simultaneously.) In that which follows, several proposed methods will be highlighted where the parameters γ and δ and will be varied in a method analogous to ASK. Additionally, the total squared amplitude, frequency, and absolute phase of the wave can be altered in addition to γ and δ thus offering very dense and bandwidth efficient modulation schemes.

Linear Polarization Rotation

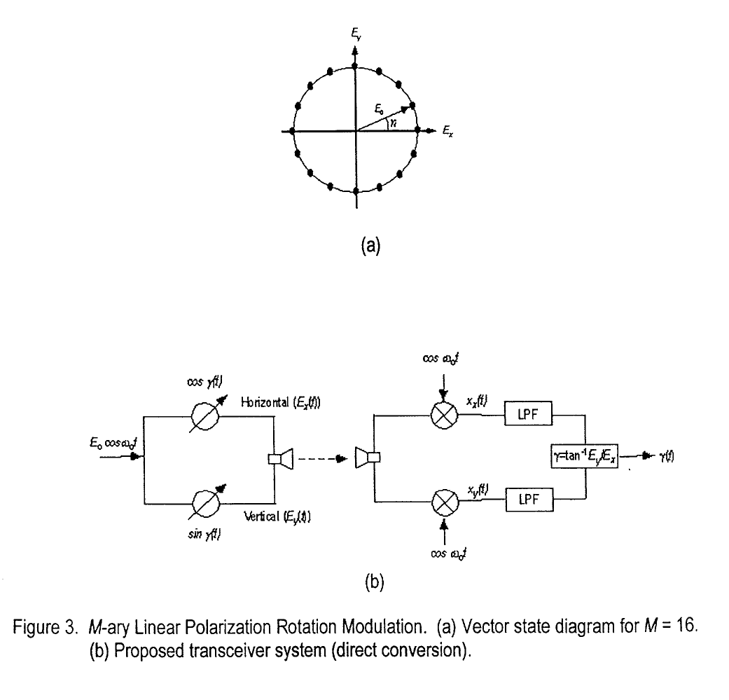

Let δ(t)=0 for all t. All polarization states will be restricted to the equator of the Poincare sphere and hence the waveform will be linearly-polarized. The modulation parameter γ(t) will rotate the polarization state from x-polarized to y-polarized as shown in FIG. 3(a). FIG. 3(b) illustrates a proposed transceiver system capable of linear polarization rotation modulation communication. Although illustrated as a wireless system, the data channel could also fiber optic with dual linear polarization. This system would be particularly useful for fixed wireless communications since the antennas can be permanently polarization aligned. Specialized signal processing may be required for systems that are not polarization aligned and/or systems in a significant multipath environment.

Binary Orthogonal Polarization Shift Keying

Any two polarization states that are on opposite sides of the Poincare sphere are orthogonal. For example, of the six states listed in Table 1, three pair are mutually orthogonal to one another, viz.,

Linear Vertical−Linear Horizontal

+45° Slant Linear−+135° Slant Linear

RHCP-LHCP

This orthogonality can be exploited to provide a binary polarization shift keying modulation. In all cases, the amplitude of the x- and y-component of the field will be of equal amplitude. Consider the case for RHCP-LHCP binary phase shift keying. The phase shift between components δ(t) will take on two values: +90° and −90°.

General Case of Stokes Parameters Shift Keying (SPSK)

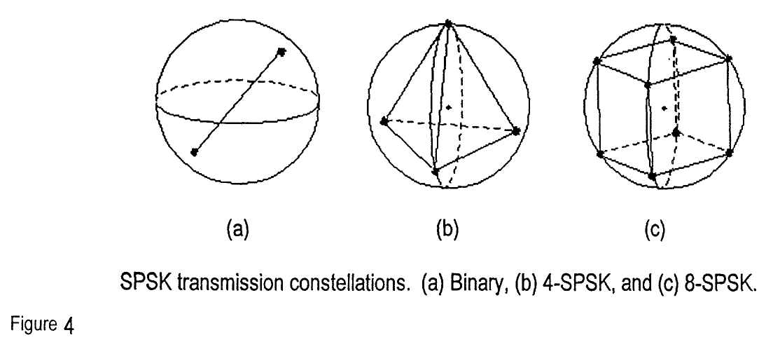

The general case of polarization modulation alters both γ and δ allowing any location on the Poincare sphere. Several authors have reported in the scientific literature the possibility of polarization modulation for optical fiber communications. SPSK transmission encodes information on a constellation of signal points in Stoke's parameters space. Each signal point corresponds to a given state of polarization and a given signal power. If only the polarization of the wave is modulated, and not is power, then all the signal points lie on the Poincare sphere. FIG. 4 illustrates examples of such signal constellations.

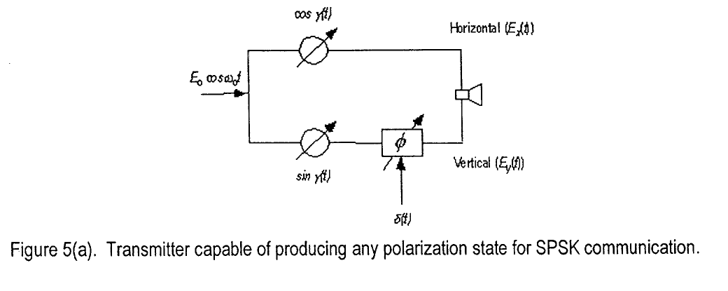

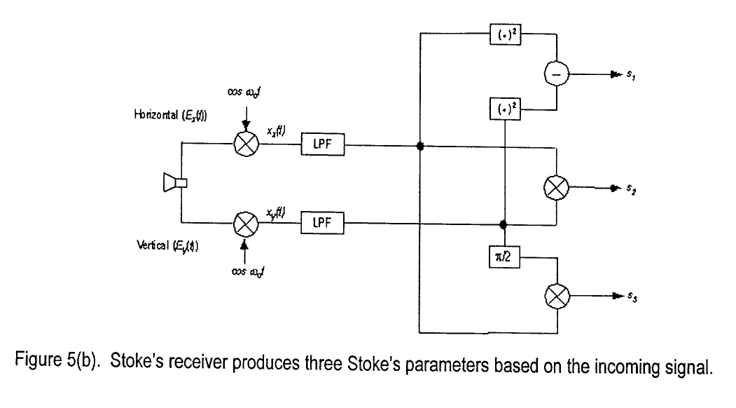

Transceiver systems for SPSK communications have been documented in the literature for optical communications. In this manuscript, we will examine a transmitter/receiver system for radio communications. FIG. 5a depicts a simplified transmitter capable of producing any polarization state. The RF carrier signal is divided into two channels: one for linear horizontal polarization and another for linear vertical. Variable gain amplifiers modulates the amplitudes of the horizontal and vertical channels using cos[γ(t)] and sin[γ(t)], respectively. A phase shifter modulates the vertical channel to provide the phase offset δ(t). These signals then drive the horizontal and vertical transmitter antenna. FIG. 5(b) depicts a Stoke's Receiver that processes the received signals into the three Stoke's parameters. The horizontal and vertical received signals are down-converted and filtered. Additional nonlinear processing is performed to implement the equations (5)-(7) to produce s₁, s₂ and s₃. This signals are then sent to a decision circuit to estimate which symbol was sent by the transmitter.

Polarization Spin Modulation And Multiplexing

Satellite communications systems have used polarization division multiple access (PDMA) for many years. Traditional PDMA uses two orthogonal polarizations to provide dual-polarization frequency reuse. Separate antennas/antenna feeds are used, each with different polarization, followed by separate transceivers allowing simultaneous access of the satellite from the same region of the earth.

An exciting new technology extends the simple two-channel PDMA technologies to allow multiple signals on a single communications resource rather than just two. With the proper signal processing, it is possible to “spin” the polarization at a prescribed rate, up to a maximum of the carrier frequency of the wave. Multiple independent communications signals may be modulated onto particular spin vector rates. There exist a continuum of spin rates that can be quantized to N unique symbols (in the case of M-ary communication) to create a highly efficient modulation method. It is conceivable, that an Mary quadrature amplitude modulation (QAM) scheme can be devices that simultaneously alters the polarization spin rate and the amplitude of the orthogonal linear polarizations thus creating a highly-dense modulation waveform. As a final technology concept, an ensemble of vector spin rates can be used in a spreading technique similar to CDMA. Individual codes would be used to spread the signal onto the various spin rates, rather than on a traditional CDMA frequency-hopping modulator.

Spin Polarized Wave Modulation (SPWM)

The general analytic expression for an arbitrarily polarized plane wave was given by equation (3) and was specialized for polarization shift keying in equation (14). For SPWM, we force δ(t)=0 so that all polarization states are on the equator of the Poincare sphere (linear polarization). Amplitudes of the horizontal and vertical channels are cycled harmonically so that the electric field vector rotates t a rotation frequency ωᵣᵢ. The analytic expression for SPWM is given by:″

\vec{E}(t)=E₀ cos ωt[\hat{x} cos ωᵣᵢt+ŷ sin ωᵣᵢt] 0≦t≦T (15)

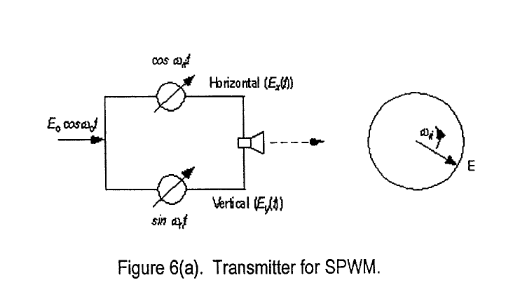

i=1, 2, . . . , M

Where ω is the carrier frequency and ωᵣᵢ is the modulating spin frequency state. FIG. 6(a) depicts a transmitter capable of transmitting a SPWM signal.

We claim:

1. A method for modulating electromagnetic waves comprising the steps of:
modulating a carrier signal by varying the polarization of said electromagnetic wave.

2. The method of claim 1 wherein the step of varying the polarization includes the steps of:
varying said polarization according to points defined by a Poincare sphere.

3. The method of claim 2 wherein said polarization states are limited to points on said Poincare Sphere which intersect the Cartesian coordinate axes.
